(19) United States
(12) Patent Application Publication
(10) Pub. No.: US 2014/0043225 A1
(43) Pub. Date: Feb. 13, 2014

(54) CONTROL METHOD AND ELECTRONIC DEVICE AND SYSTEM EMPLOYING THE SAME

(71) Applicant: HON HAI PRECISION INDUSTRY CO., LTD., New Taipei (TW)

(72) Inventors: CHUN-HUNG LAI, New Taipei (TW); CHIH-CHUN CHANG, New Taipei (TW)

(73) Assignee: HON HAI PRECISION INDUSTRY CO., LTD., New Taipei (TW)

(21) Appl. No.: 13/869,250

(22) Filed: Apr. 24, 2013

(30) Foreign Application Priority Data
Aug. 10, 2012 (TW) 101128908

(51) Int. Cl. G06T 3/40

(52) U.S. Cl. CPC G06T 3/40
USPC 345/156

(57) ABSTRACT

An electronic device for controlling a display device includes a computing module, an adjusting module and a first communication module. The computing module computes a distance D between the electronic device and the display device capable of communicating with the electronic device. The adjusting module generates an adjusting signal according to the distance D. The first communicating module is configured to transmit the adjusting signal to the display device, for adjusting the size of an image displayed on the display device corresponding to the adjusting signal.

### BACKGROUND

1. Technical Field

The present disclosure relates to an electronic device, and particularly to an electronic device capable of adjusting the size of an image displayed on a display device and a control method applied to the electronic device.

2. Description of Related Art

Display devices, such as televisions and computer systems all employ a screen for displaying an image. The image may occupy the entire display screen and for some monitors or televisions the size of the image displayed on the screen cannot be changed. When people view the display device having a large screen at a close position for a long time, their eyes may get strained. When people view the display device from an extended distance, they may find it difficult to view the image clearly. Thus, it is difficult to satisfy different needs from different users because of the set size of the image displayed on the screen.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an electronic system including a display device and an electronic device in accordance with a first embodiment.

FIG. 2 shows a schematic view for explaining the calculation of the distance between the display device and the electronic device of FIG. 1 in according with the first embodiment.

FIG. 3 is a flowchart of a control method of the electronic device in accordance with the first embodiment.

FIG. 4 is a block diagram of an electronic system including a display device and an electronic device in accordance with a second embodiment.

FIG. 5 shows a schematic view explaining the calculation of the distance between the display device and the electronic device of FIG. 4 in accordance with the second embodiment.

FIG. 6 is a flowchart of a control method of the electronic device in accordance with the second embodiment.

### DETAILED DESCRIPTION

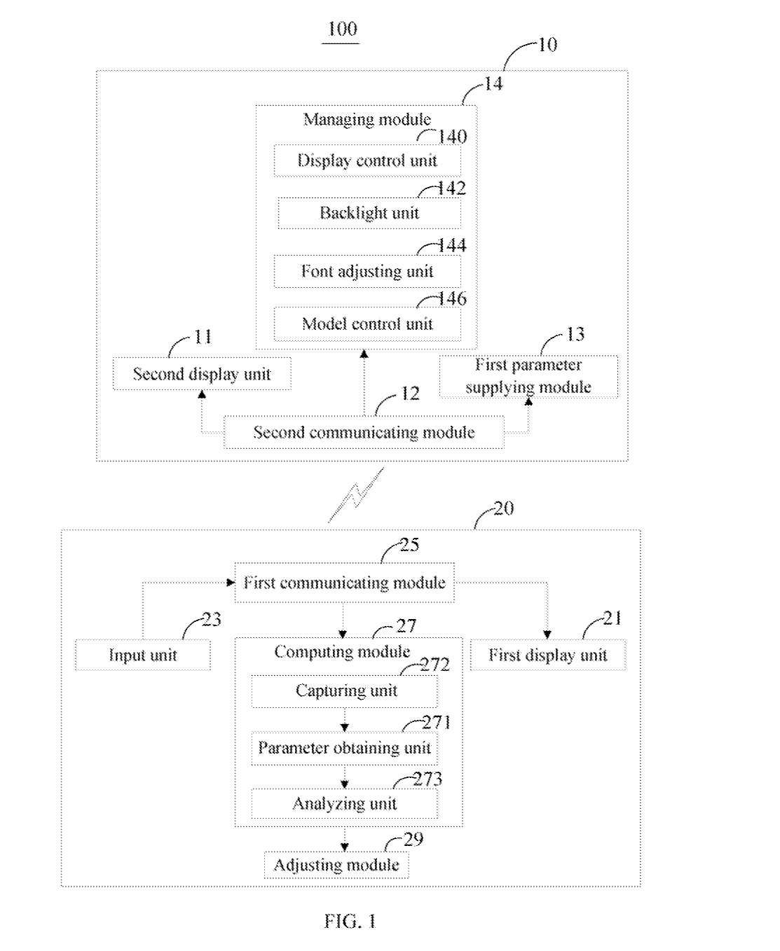

FIG. 1 shows an electronic system 100 in accordance with a first embodiment. The electronic system 100 includes a display device 10 and an electronic device 20 capable of communicating with the display device 10. The display device 10 is capable of outputting audio and video signals. The display device 10 may be a television or a computer. The electronic device 20 is capable of adjusting the size of an image displayed on the display device 10. The electronic device 20 may be a remote control, a mobile phone, a personal digital assistant (PDA) or a tablet personal computer. The electronic device 20 is capable of communicating with the display device 10 via Wireless, such as Wireless Fidelity (WI-FI), BLUETOOTH or infrared. In the embodiment, the display device 10 is a television. The electronic device 20 is a mobile phone. The electronic device 20 communicates with the display device 10 via WI-FI.

The electronic device 20 includes a first display unit 21, an input unit 23, a first communicating module 25, a computing module 27, and an adjusting module 29. The display device 10 includes a second display unit 11, a second communicating module 12, a first parameter supplying module 13 and a managing module 14. When the first communicating module 25 communicates with the second communicating module 12 in response to the operations of a user, the electronic device 20 intercommunicates with the display device 10.

The first display unit 21 is used for displaying information of the electronic device 20, such as pictures or icons.

The second display unit 11 is used for displaying the image of the display device 10. In the embodiment, the second display unit 11 is a Liquid Crystal Display (LCD).

The input unit 23 generates different control signals in response to the operations of a user. In this embodiment, the control signals include a communication signal and a trigger signal. The input unit 23 may be a plurality of buttons or keys located on the electronic device 20. The user can operate the predetermined buttons to generate the different control signals. For example, the user can press a first predetermined button to generate the communication signal. The user can press a second predetermined button to generate the first trigger signal.

The first communicating module 25 establishes communication with the second communicating module 12 of the display device 10, when the input unit 23 generates a communication signal in response to the operations of the user.

The first parameter supplying module 13 of the display device 10 feedbacks a first parameter S₁ to the computing module 27, when the input unit 23 generates the trigger signal in response to operations of the user, the first parameter S₁ is a value representing the length or width of the image displayed on the second display unit 11, which is stored in the first parameter supplying module 13 previously. In the embodiment, the first parameter S₁ is the width value of the image displayed on the second display unit 11. For example, when the diagonal of the second display unit 11 is 153 centimeters (cm), with the length value of the second display unit 11 is 133 cm and the width value of the second display unit 11 is 75 cm, the first parameter S₁ is 75 cm. When the diagonal of the second display unit 11 is 107 cm, with the length value of the second display unit 11 is 92 cm and the width value of the second display unit 11 52 cm, the first parameter S₁ is 52 cm.

The computing module 27 is used for computing a distance D between the electronic device 20 and the display device 10. The computing module 27 includes a parameter obtaining unit 271, a capturing unit 272 and an analyzing unit 273.

The capturing unit 272 captures an image of the image displayed on the second display unit 11 and supplies the captured image to the parameter obtaining unit 271. In the embodiment, the capturing unit 272 is an optical zoom camera arranged on a surface of the electronic device 20. When the capturing unit 272 captures the image of the image displayed on the second display unit 11, an imaging region frame displays on the first display unit 21 of the electronic device 20. When a focal length L₁ of the capturing unit 272 is adjusted to a predetermined value, the imaging region frame superposes with the image displayed on the whole second display unit 11.

The parameter obtaining unit 271 obtains the first parameter S₁ from the first parameter supplying module 13 of the display device 10 and a second parameter S₂ from the captured image. The second parameter S₂ is the length or width value of the captured image corresponding to the first parameter S₁. In the embodiment, the second parameter S₂ is the width value of the captured image corresponding to the image displayed on the second display unit 11.

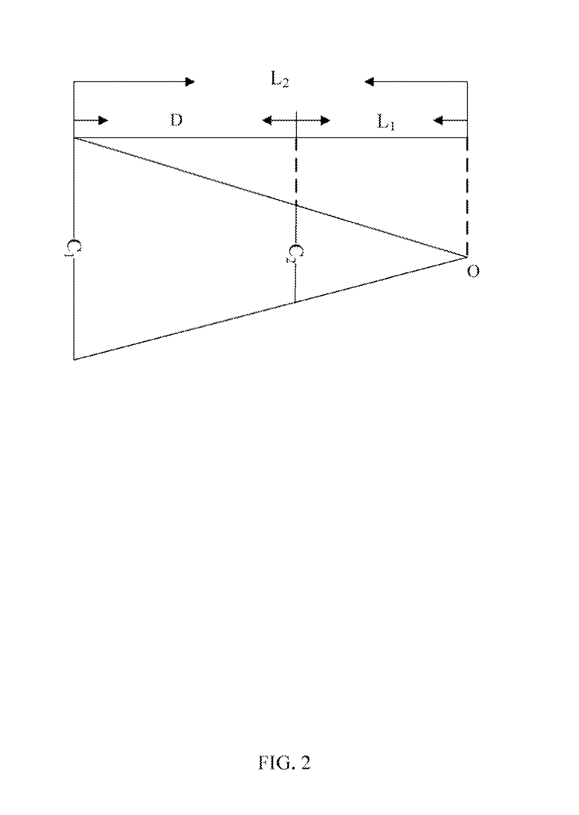

FIG. 2 shows the analyzing unit 273 computing the distance between the display device 10 and the capturing unit 272 of the electronic device 20 according to the first and second parameters S₁ and S₂. Wherein, the length C₁ represents the width of the image displayed on the second display unit 11 and corresponds to the first parameter S₁. The length C₂ represents the width of the image captured by the capturing unit 272 and corresponds to the second parameter S₂. The capturing unit 272 is arranged on the electronic device 20, thus, the distance D between the display device 10 and the electronic device 20 is equal to the display device 10 and the capturing unit 272. The analyzing unit 273 computes a distance L₂ between a focal point O of the lens of the capturing unit 272 and the display device 10 according to the equation:

$$\frac{{C}_{1}}{{C}_{2}} = \frac{{L}_{2}}{{L}_{1}} .$$

The analyzing unit 273 further computes the distance D according to the equation: D=(L₂−L₁). In other embodiment, the distance D can be computed by other methods.

In the embodiment, the diagonal of the second display unit 11 is 153 cm, and the length C₁ is 75 cm. Thus, the first parameter S₁ is 75 cm. When the focal length L₁ of the capturing unit 272 is adjusted to 5 cm, the imaging region frame superposes with the image displayed on the second display unit 11. The parameter obtaining unit 271 obtains the length C₂ of the image being 2.5 cm after being captured by the capturing unit 272. Thus, the second parameter S₂ is 2.5 cm.

The analyzing unit 273 computes the distance d₂ between the focal point O and the display device 10 according to the equation:

$$\frac{{C}_{1}}{{C}_{2}} = \frac{{L}_{2}}{{L}_{1}} ,$$

and computes the distance D between the electronic device 20 and the display device 10 according to the equation: D=(L₂−L₁). Thus, the distance d₂ between the focal point O and the display device 10 is 150 cm, and the distance D between the electronic device 20 and the display device 10 is 145 cm.

The adjusting module 29 generates an adjusting signal according to the distance D between the electronic device 20 and the display device 10. In the embodiment, the relationship between the distance D and the size of the image displayed on the second display unit 11 is previously stored in the adjusting module 29. In the embodiment, the distance D is in directly proportional to the size of the image. For example, when the diagonal of the second display unit 11 is 153 cm and the distance D is within a range between 10 cm and 150 cm, the size of the image displayed on the second display unit 11 is adjusted to 28 inches. When the distance D between the electronic device 20 and the display device 10 is within a range between 150 cm and 200 cm, the size of the image displayed on the second display unit 11 is adjusted to 36 inches.

The first communicating module 25 further transfers the adjusting signal to the display device 10.

The managing module 14 includes a display control unit 140. The display control unit 140 adjusts the size of the image displayed on the first display unit 21 according to the adjusting signal.

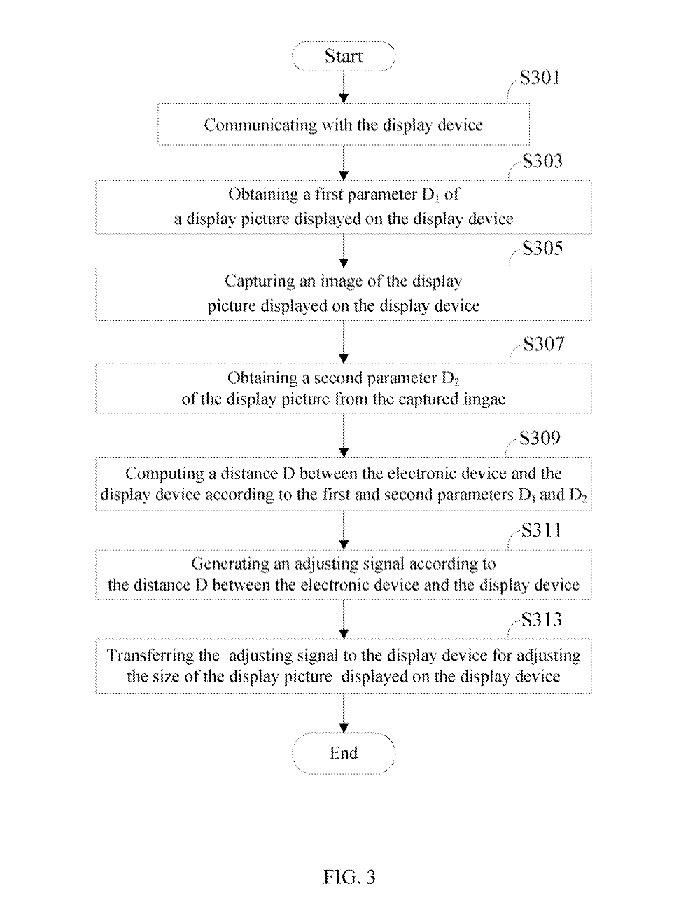

FIG. 3 shows that a control method is applied to the electronic device 20 for adjusting an image display on a display device 10. The control method includes the following steps:

In step S301, the electronic device 20 is activated to communicate with the display device 10.

In step S303, the parameter obtaining unit 271 obtains a first parameter S₁ of the image displayed on the display device 10. The first parameter S₁ is a value representing the width or length of the image displayed on the second display unit 11.

In step S305, the capturing unit 272 captures an image of the image displayed on the display device 10.

In step S307, the parameter obtaining unit 271 obtains a second parameter S₂ of the image from the captured image. The second parameter S₂ is a value representing the length or width of the image corresponding to the first parameter S₁ after being captured in the image.

In step S309, the analyzing unit 27 computes a distance D between the electronic device 20 and the display device 10 according to the first parameter S₁ and the second parameter S₂. When the focal length L₁ is adjusted to a predetermined value, the imaging region frame superposes with the image displayed on the whole screen 11. The electronic device 20 computes a distance L₂ between a focal point O of the electronic device 20 and the display device 10 according to the equation:

$$\frac{{C}_{1}}{{C}_{2}} = \frac{{L}_{2}}{{L}_{1}} ,$$

and further computers the distance D between the electronic device 20 and the display device 10 according to the equation: D=(L₂−L₁).

In step S311, the adjusting module 29 generates an adjusting signal according to the distance D between the electronic device 20 and the display device 10.

In step S313, the first communicating module 25 transfers the adjusting signal to the display device 10 for adjusting the size of the image displayed on the display device 10.

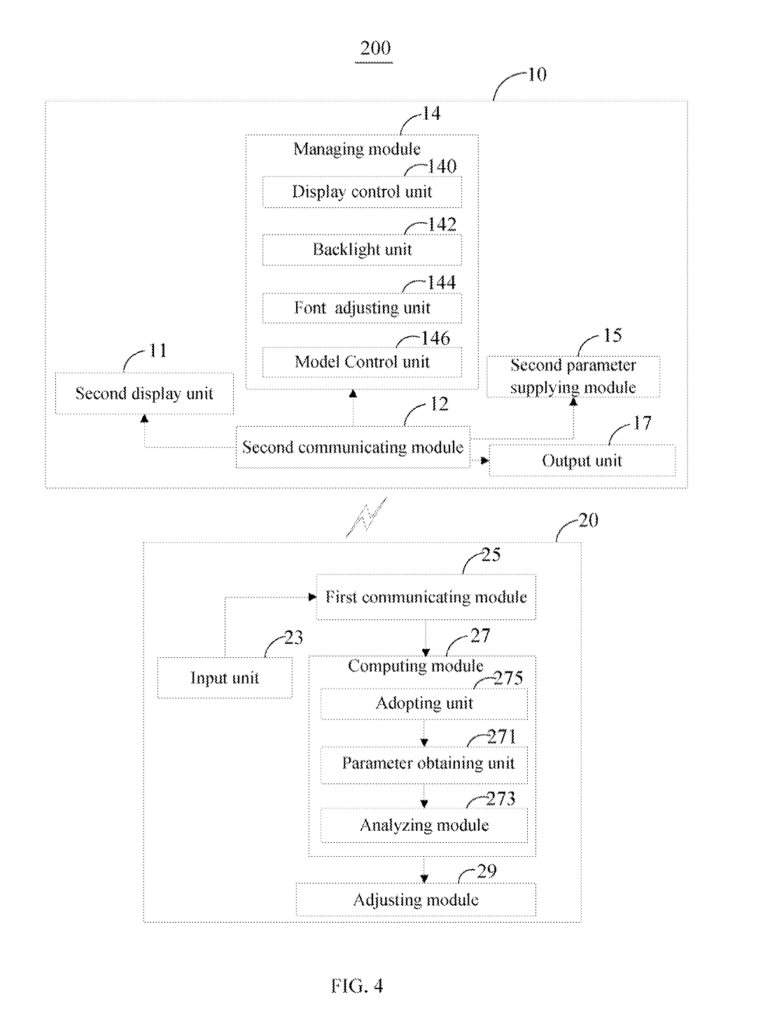

FIG. 4 shows an electronic system 200 in accordance with a second embodiment. The electronic system 200 according to the second embodiment has the substantially same arrangement as that of the electronic 100 according to the first embodiment described above, except a second parameter supplying module 15 replacing the first parameter supplying module 13 of the display device 10, and an adopting unit 275 replacing the capturing unit 272 of the electronic device 20. Furthermore, the first display unit 21 of the electronic device 20 is omitted, and an output unit 17 is added to the display device 10.

When the input unit 23 generates the second trigger signal in response to the operations of the user, the output unit 17 outputs a first audio signal. In the embodiment, the output unit 17 is a speaker. The volume of the first audio signal is predetermined In other embodiment, a user via a remote control of the display device 10 can set the volume of the first audio signal.

The second parameter supplying module 15 supplies a first parameter W₁ of the first audio signal to the computing module 27. In the embodiment, the first parameter W₁ is a power value of the first audio signal and is previously stored in the second parameter supplying module 15.

The computing module 27 is used for counting the distance D between the electronic device 20 and the display device 10.

The adopting unit 274 receives the first audio signal being outputted by the output unit 17 to obtain a second audio signal and supplies the second audio signal to the parameter obtaining unit 271. The second audio signal is attenuated relative to the first audio signal after being transmitted for a predetermined distance. In the embodiment, the adopting unit 274 is a microphone.

The parameter obtaining unit 271 obtains the first parameter W₁ from the second parameter supplying module 15 and a second parameter W₂ from the second audio signal. In the embodiment, the second parameter W₂ is a power value of the second audio signal.

The analyzing unit 273 obtains a difference value W by comparing the first parameter W₁ and the second parameter W₂, and computes the distance D according to the difference value W. In the embodiment, the difference value W is computed according to the equation: W₂−W₁.

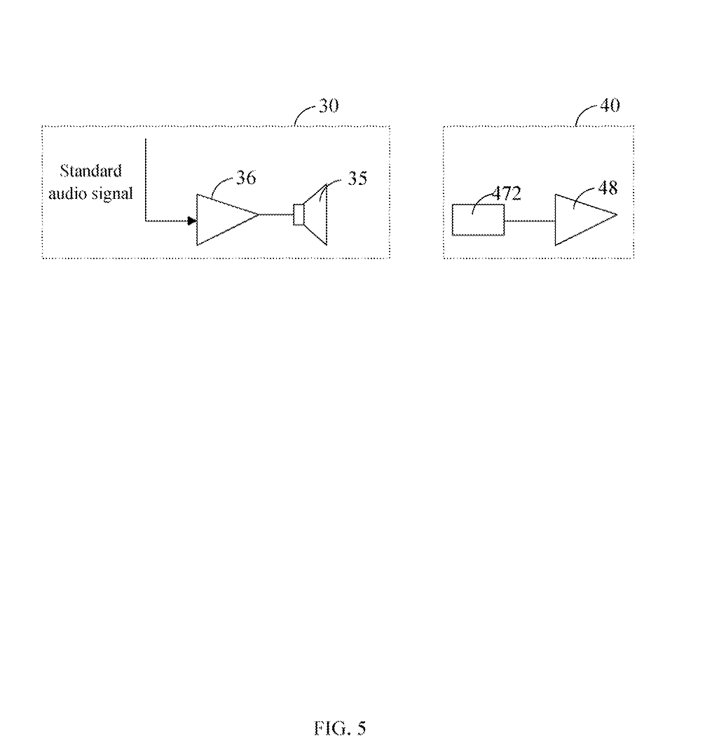

FIG. 5 shows that in the embodiment, the display device 10 includes a first amplifier 36 connected to the audio output unit 17. The electronic device 20 includes a second amplifier 48 connected to the adopting unit 275. The analyzing unit 273 can obtain the difference value W via two method as follow:

(1) When receiving the second trigger signal, the display device 10 generates a standard audio signal. The standard audio signal is amplified to a predetermined multiple by the first amplifier 36 to form the first audio signal outputted by the output unit 17. The adopting unit 275 receives the first audio signal being outputted by the output unit 17 to obtain a second audio signal. Because the first audio signal is attenuated after being transmitted for a predetermined distance, the power value of the second audio signal is less than that of the first audio signal. The analyzing unit 273 obtains the difference value W by comparing the second parameter W₂ of the second audio signal and the first parameter W₁ of the first audio signal and computers the distance D according to the equation: W=201g D.

(2) When receiving the second trigger signal, the display device 10 generates a standard audio signal. The standard audio signal is amplified to a first multiple by the first amplifier 36 to form the first audio signal outputted by the output unit 17. The adopting unit 275 receives the first audio signal outputted by the output unit 17 to obtain a second audio signal. Because the first audio signal is attenuated after being transmitted for a predetermined distance, the power value of the second audio signal is less than that of the first audio signal. The second amplifier 48 amplifies the second audio signal to a second multiple X for boosting the second audio signal to a third audio signal having the same power as the first audio signal. The analyzing unit 273 obtains the difference value W by the second multiple and the second audio signal according to the equation: W=XW₂. The analyzing unit 273 further computers the distance D according to the equation: W=201g D.

In the embodiment, the standard audio signal and the amplified multiple of the first amplifier 36 can be set by users according to need, such as, the standard audio signal is 1 decibel, the amplified multiple of the first amplifier 36 is 5 times.

The adjusting module 29 generates an adjusting signal according to the distance D between the electronic device 20 and the display device 10. In the embodiment, the relationship between the distance D and the size of the image displayed on the second display unit 11 is previously stored in the adjusting module 29. In the embodiment, the distance D is in directly proportional to the size of the image. For example, when the diagonal of the second display unit 11 is 107 cm and the distance D is within a range between 10 cm and 150 cm, the size of the image displayed on the second display unit 11 is adjusted to 28 inch. When the distance D between the electronic device 20 and the display device 10 is within a range between 150 cm and 200 cm, the size of the image displayed on the second display unit 11 is adjusted to 36 inches.

The first communicating module 25 further transfers the adjusting signal to the display device 10.

The managing module 14 adjusts the size of the image displayed on the second display unit 11 according to the adjusting signal.

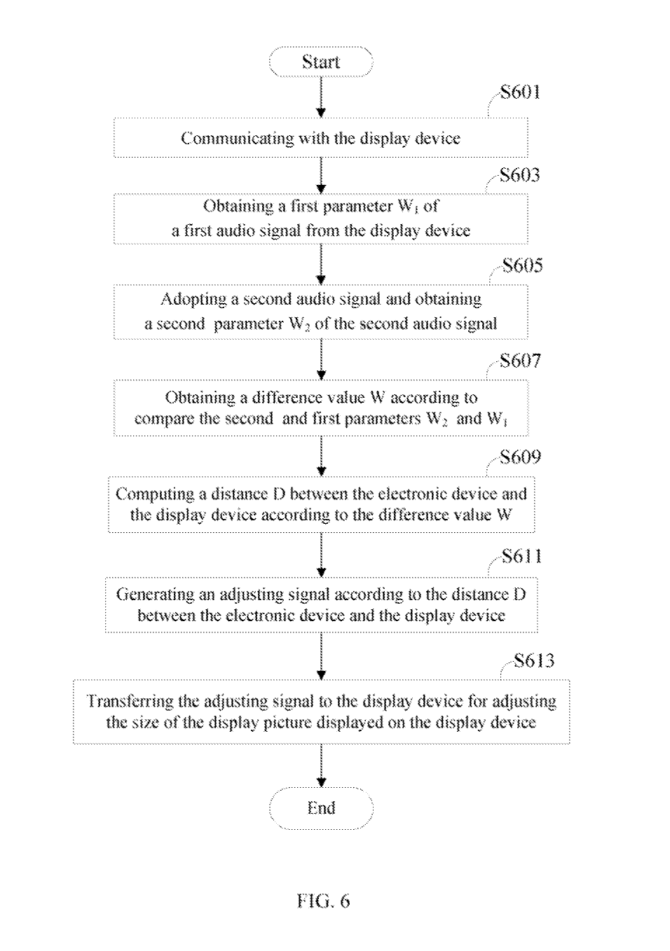

FIG. 6 shows that a control method is applied to the electronic device 20 for adjusting an image displayed on the display device 10. The control method includes the following steps:

In step S601, the electronic device 20 is activated to communicate with the display device 10.

In step S603, the parameter obtaining unit 271 obtains a first parameter W₁ of a first audio signal from the display device 10. The first parameter W₁ is a power value of the first audio signal.

In step S605, the adopting unit 275 adopts a second audio signal and supplies the second audio signal to the parameter obtaining unit 271.

In step S607, the parameter obtaining unit 271 obtains a second parameter W₂ of the second audio signal. The second audio signal is attenuated relative to the first audio signal after being transmitted for a predetermined distance. The second parameter W₂ is a power value of the second audio signal.

In step S609, the analyzing unit 273 obtains a difference value W by comparing the second parameter W₂ and the first parameter W₁ and computes the distance D between the electronic device 20 and the display device 10 according to the difference value W. In the embodiment, the difference value W is computed according to the equation: W₂−W₁. The distance D is computed according to the equation: W=201g D.

In step S611, the adjusting module 29 generates an adjusting signal according to the distance D between the electronic device 20 and the display device 10.

In step S613, the first communicating module 25 transfers the adjusting signal to the display device 10 for adjusting the size of the image displayed on the second display unit 11.

FIGS. 1 and 4 show that the managing module 14 of the display device 10 includes a backlight unit 142, a font adjusting unit 144 and a model control unit 146. The control signals from the input units 21 of the electronic device 20 may further include a backlight control signal, a font adjusting signal and a model control signal. The user can operate predetermined buttons or icons to generate the different control signals.

After the size of image displayed on the second display unit 11 being adjusted, the electronic device 20 is further capable of controlling a backlight unit 142 of the display device 10, the size of the font and the model of the image displayed on the second display unit 11.

The backlight unit 142 includes a plurality of Light Emitting Diodes (LED) function as the light source. When the input unit 13 generates the backlight control signal in response to the operations of the user, the backlight unit 142 of the display device 10 turns off a portion of the Light Emitting Diodes corresponding to the second display unit 11 without displaying the image in responses to the backlight control signal, for saving energy of the display device 10. For example, when the size of the image displayed on the second display unit 11 is adjusted from 60 inches to 48 inches, the electronic device 20 controls the backlight unit 142 of the display device 10 to turn off a portion of the Light Emitting Diodes corresponding to the second display unit 11 without displaying the image.

When the input unit 23 generates the font adjusting signal in responses to the operations of the user, the font adjusting unit 144 adjusts the font size to a size in response to the font adjusting signal. In the embodiment, the font size is directly proportional to the distance D. For example, when the distance D between the electronic device 20 and the display device 10 is in a range between 50 cm and 100 cm, the font adjusting unit 144 adjusts the font size to 9 point. When the distance D between the electronic device 20 and the display device 10 is in a range between 100 cm and 150 cm, the font adjusting unit 17 adjusts the font size to 14 point.

When the input unit 23 generates the model control signal in response to the operations of the user, the model control unit 146 displays a plurality of assistant interfaces around the image in the form of Picture-In-Picture (PIP) or Picture-Out-Picture (POP). For example, when the size of the image displayed on the second display unit 11 is adjusted from 60 inches to 48 inches, the model control unit 146 displays a plurality of assistant interfaces, such as, TV channel menu, video displaying window, around the image in the form of Picture-Out-Picture (POP).

Although information and the advantages of the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. An electronic device capable of communicating with a display device, the electronic device comprising:
a computing module for computing a distance D between the electronic device and the display device;
an adjusting module for generating an adjusting signal according to the distance D; and
a first communicating module configured to transmit the adjusting signal to the display device, for adjusting the size of an image displayed on the display device corresponding to the adjusting signal.

2. The electronic device as claimed in claim 1, wherein the computing module comprises a capturing unit, a parameter obtaining unit and an analyzing unit; the capturing unit captures an image of the image displayed on the display device, the parameter obtaining unit obtains a first parameter S₁ of the image displayed on the display device and a second parameter S₂ of the image in the image, and the analyzing unit computes the distance D according to the first and second parameters S₁ and S₂.

3. The electronic device as claimed in claim 2, wherein the first parameter S₁ is a value representing the length or width of the image displayed on the display device, and the second parameter S₂ is a value representing the other of the length or width of the image being captured in the image.

4. The electronic device as claimed in claim 1, wherein the computing module comprises an adopting unit, a parameter obtaining unit and an analyzing unit; the parameter obtaining unit obtains a first parameter W₁ of a first audio signal from the display device, the adopting unit receives a second audio signal formed by the first audio signal, the parameter obtaining unit further obtains a second parameter W₂ of the second audio signal; the analyzing unit computes the distance D according to a difference value W between the first parameter W₁ and the second parameter W₂.

5. The electronic device as claimed in claim 4, wherein the first parameter W₁ is the power of the first audio signal, and the second parameter W₂ is the power of the second audio signal, and the difference value W is an attenuation value of the second parameter W₂ relative to the first parameter W₁.

6. The electronic device as claimed in claim 1, wherein the distance D is directly proportional to the size of the image displayed on the display device which stored in the adjusting module.

7. The electronic device as claimed in claim 1, further comprising an input unit, wherein the input unit generates a backlight control signal according to user's operation, for turning off the backlight of the display device without displaying the image.

8. The electronic device as claimed in claim 1, further comprising an input unit, wherein the input unit generates a font adjusting signal in response to user's operation, for adjusting the font size displayed on the display device.

9. The electronic device as claimed in claim 1, further comprising an input unit, wherein the input unit generates a model control signal in response to user's operations, for controlling the display device to display a plurality of assistant interfaces around the image in the form of Picture-In-Picture or Picture-Out-Picture.

10. An electronic system, comprising:
a display device capable of displaying an image; and
an electronic device communicating with the display device; the electronic device comprising:
a computing module for computing a distance D between the electronic device and the display device;
an adjusting module for generating an adjusting signal according to the distance; and
a first communicating module configured to transmit the adjusting signal to the display device;
wherein when receiving the adjusting signal from the first communicating module, the display device adjusts the size of the image to a fitting size according to the adjusting signal.

11. The electronic system as claimed in claim 10, wherein the computing module comprises a capturing unit, a parameter obtaining unit and an analyzing unit; the capturing unit captures an image of the image displayed on the display device, the parameter obtaining unit obtains a first parameter S₁ of the image displayed on the display device and a second parameter S₂ of the image in the image, and the analyzing unit computes the distance D according to the first and second parameters S₁ and S₂.

12. The electronic system as claimed in claim 11, wherein the first parameter S₁ is a value representing the length or width of the image displayed on the display device, and the second parameter S₂ is a value representing the length or width of the image being captured in the image.

13. The electronic system as claimed in claim 10, wherein the computing module comprises an adopting unit, a parameter obtaining unit and an analyzing unit; the parameter obtaining unit obtains a first parameter W₁ of a first audio signal from the display device, the adopting unit receives a second audio signal formed by the first audio signal, the parameter obtaining unit further obtains a second parameter W₂ of the second audio signal; the analyzing unit computes the distance D according to a difference value W between the first parameter W₁ and the second parameter W₂.

14. The electronic system as claimed in claim 13, wherein the first parameter W₁ is the power of the first audio signal, and the second parameter W₂ is the power of the second audio signal; the difference value W is an attenuation value of the second parameter W₂ relative to the first parameter W₁.

15. The electronic system as claimed in claim 10, further comprising an input unit, wherein the input unit generates a backlight control signal in response to user's operation to turn off the backlight of the display device without displaying the image; the input unit further generates a font adjusting signal in response to user's operations to adjust the font size displayed on the display device.

16. A control method, comprising:
obtaining a distance D between an electronic device and a display device;
generating an adjusting signal according to the distance D; and
adjusting the size of an image displayed on the display device.

17. The control method as claimed in claim 16, wherein the step of obtaining the distance D comprises:
obtaining a first parameter S₁ of the image displayed on the display device;
capturing an image of the image;
obtaining a second parameter S₂ of the image in the image; and
computing the distance D according the first parameter S₁ and the second parameter S₂.

18. The control method as claimed in claim 17, wherein the first parameter S₁ is a value representing the length or width of the image displayed on the display device, and the second parameter S₂ is a value representing the length or width of the image being captured in the image.

19. The control method as claimed in claim 16, wherein the step of obtaining the distance D comprises:
obtaining a first parameter value W₁ of a first audio signal from the display device;
adopting a second audio signal formed by the first audio signal;
obtaining a second parameter W₂ of the second audio signal;
obtaining a difference value W between the first parameter value W₁ and the second parameter W₂; and
computing the distance D according to the difference value W.

20. The control method as claimed in claim 19, wherein the first parameter W₁ is the power of the first audio signal, and the second parameter W₂ is the power of the second audio signal, and the difference value W is an attenuation value of the second parameter W₂ relative to the first parameter W₁.
